(19) United States
(12) Patent Application Publication
(10) Pub. No.: US 2021/0368068 A1
(43) Pub. Date: Nov. 25, 2021

(54) PRINTING DEVICES

(71) Applicant: Hewlett-Packard Development Company, L.P., Spring, TX (US)

(72) Inventors: Wesley R Schalk, Vancouver, WA (US); Morgan T. Schramm, Vancouver, WA (US); Jesse Sutherland, Vancouver, WA (US); Ranjit Bhaskar, Vancouver, WA (US); Erik A Anderson, Vancouver, WA (US)

(21) Appl. No.: 16/499,307

(22) PCT Filed: Apr. 27, 2018
(86) PCT No.: PCT/US2018/029845

§ 371 Date: Sep. 29, 2019

(51) Int. Cl. H04N 1/60; G06F 3/12

(52) U.S. Cl. CPC H04N 1/6019; G06F 3/1208; H04N 1/6097; H04N 1/605

(57) ABSTRACT

An example printing device and method of the printing device is disclosed. A print substance formulation is modulated based on the process characteristic for a selected medium. A print substance is delivered to the selected medium according to the modulated print substance formulation.

### BACKGROUND

Printing devices—including printers, copiers, fax machines, multifunction devices including additional scanning, copying, and finishing functions, all-in-one devices, or other devices such as pad printers to print images on three dimensional objects and three-dimensional printers (additive manufacturing devices)—employ color management systems to deliver a controlled conversion between color representations of various devices, such as image scanners, digital cameras, computer monitors, and software applications. Device profiles provide color management systems with information to convert color data between color spaces such as between native device color spaces and device-independent color spaces, between device-independent color spaces and native device color spaces, and between source device color spaces and directly to target device color spaces such as printing device color spaces.

### BRIEF DESCRIPTION OF THE DRAWINGS

FIG. 1 is a block diagram illustrating an example method.

FIG. 2 is a block diagram illustrating an example printing device implement the example method of FIG. 1.

FIG. 3 is a block diagram illustrating an example system to implement the example method of FIG. 1, which can be included in the example printing device of FIG. 2.

### DETAILED DESCRIPTION

A color space is a system having axes and that describes color numerically. Some output devices, such as printing devices, may employ a type of subtractive color space, which can include a type of cyan-magenta-yellow-key (black) (CMYK) color space, while some software applications and display devices may employ a type of additive color space, which can include a type of red-green-blue (RGB) color space. For example, a color represented in an RGB color space has a red component value, a green component value, and a blue component value, and a color represented in a CMYK color space has a cyan component value, a magenta component value, a yellow component value, and a black or key component value, that combined numerically represent the color. A color gamut for a device is a property of the device that includes the range of color (and density/tonal values) that the device can produce as represented by a color space. As used in this disclosure, a process color component includes the cyan, magenta, and yellow components in the subtractive color space and does not include the black component in the subtractive color space.

A color management resource, is a set of data based on the color gamut characterization in a color space. A color profile is an example of a color management resource. A color profile is a formal set of data that characterizes the color gamut in a color space. In one example, a color profile can describe the color attributes of a particular device or viewing specifications with a mapping between the device-dependent color space, such as a source or target color space, and a device-independent color space, such as profile connection space (PCS), and vice versa. The mappings may be specified using tables such as look up tables, to which interpolation can be applied, or through a series of parameters for transformations. Devices and software programs—including printing devices, monitors, televisions, and operating systems—that capture or display color can include color profiles that comprise various combinations of hardware and programming. An ICC profile is an example color profile that is a set of data that characterizes a color space according to standards promulgated by the International Color Consortium (ICC). Examples of this disclosure using particular profiles, such as ICC profiles, however, are for illustration only, and the description is applicable to other types of color profiles, color management resources, or color spaces.

The ICC profile framework has been used as a standard to communicate and interchange between various color spaces. An ICC output profile includes color table pairs, so-called A2B and B2A color look up tables, where A and B denote the device-dependent and the device-independent color spaces, respectively. For different devices, there are different look up table rendering intent pairs. For example, an ICC profile allows for three color table pairs, enumerated from 0 to 2, enabling the user to choose from one of the three possible rendering intents: perceptual, colorimetric, or saturation. ICC profiles are often embedded in color documents as various combinations of hardware and programming to achieve color fidelity between different devices. The size of color tables will increase with finer sampling of the spaces and larger bit depths.

Color tables that provide transformations between various color spaces are extensively used in color management, common examples being the transformations from device independent color spaces (such as CIELAB, i.e., L*a*b*) to device dependent color spaces (such as RGB or CMYK) and vice versa. The mappings may be specified using tables such as single dimensional or multidimensional look-up tables, to which interpolation can be applied, or through a series of parameters for transformations. A color table can include an array or other data structure stored on a memory device that replaces runtime computations with a simpler array indexing operation as a color look-up table. Color tables can also include monochromatic and greyscale color tables. In a greyscale table, for example, the value corresponding to a source color space such as RGB can be of luminous intensity.

Printing devices, including printing devices that print in color mode and printing devices that print in black and white or monochromatic mode, employ color management systems including color management resources to deliver a controlled conversion between color representations of various devices, such as image scanners, digital cameras, computer monitors, printers, and software applications including operating systems, browsers, and photo and design programs often to a subtractive color space or a monochromatic color space such as greyscale. In general, printing devices apply a print substance, which can include printing agents or colorants often in a subtractive color space or black, to a medium via a device component generally referred to as a print head. A medium can include various types of print media, such as plain paper, photo paper, polymeric substrates and can include any suitable object or materials to which a print substance from a printing device are applied including materials, such as powdered build materials, for forming three-dimensional articles. Print substances, such as printing agents, marking agents, and colorants, can include toner, liquid inks, or other suitable marking material that may or may not be mixed with fusing agents, detailing agents, or other materials and can be applied to the medium.

Printing devices often employ color tables to provide transformations between input color spaces and subtractive color spaces to determine corresponding formulations of print substance amounts, such as print substance volumes, to render the intended colors. In one example, printing devices often employ color tables including multidimensional color look-up tables to provide transformations between different color spaces such as from input device-independent colors to CMYK print substance amounts in the case of two-dimensional printing devices for printing on substrates or, in the case of three-dimensional printing devices, printing agent amounts for printing on a powder or other material. Many colors in the gamut of a CMYK color space for printing devices can be rendered from just the set of process colors of cyan, magenta, and yellow and, in some color resource models, do not include a black component. In many printing devices and printing modes, however, an achromatic black component can be added to some of colors in in the CMYK color space order to reduce process color print substance consumption for some darker colors, stabilize neutral color such as in the grey tones, and to improve printability of blacks.

For printing devices, color management resources including the color tables can be embedded in memory devices storing the printer firmware or other hardware such as a controller. In some examples, the particular color transform of the color management resource may be colorant-dependent, such as dependent on the particular formulation of each of the print substance included in a supply component such as a print substance cartridge, and information regarding the color gamut characterization in the color management resource can be stored on a memory device located on the cartridge for use with the printing device such as its firmware or other hardware.

In one example, a color management resource for a printing device may include a plurality of multidimensional color tables that can correspond to media, rendering intents, and colorant axes of a color gamut, among other things, included in a color profile. In general, a profile can include N color tables to be processed, such as CLUT₁, CLUT₂, . . . , CLUT_{N}, and the input color space includes Jᵢₙ channels. In one example, multiple color tables representing different rendering intents can be included with one ICC profile. Additionally, the output color space includes Jₒᵤₜ channels, and in many examples of an ICC profile Jᵢₙ and Jₒᵤₜ can be 3 or 4 channels. For each output channel, the corresponding lookup table contains M^{J}^{ᵢₙ} nodes. For example, each color table can include M⁴ nodes for each of the cyan, magenta, yellow, and black colorants corresponding with each print substance color used in the printing device or M³ nodes for each of the red, green, and blue three additive primaries corresponding with each primary color used in the display device. Additionally, each type of medium used in the printing device can include a set of color tables.

The quality of an image produced with a printing device is generally based on a print substance amount for a given medium. For example, more print substance amount produces a more vibrant image on a medium. Similarly, a depleted print substance amount transformation, such an amount of print substance that is uniformly scaled back from a full color formulation, is generally believed to produce an image on the medium that has less appeal than a full color image. Print substance amount is often limited by an ability or capacity of the medium to receive or absorb the print substance. Print substance formulations may differ for different media depending on the ability of the medium to receive the print substance or the affect of the print substance on the medium. Additionally, the print process may be modified to address the ability of the medium to receive the print substance such as the print process may proceed at a selected speed in order to permit a print fluid, such as ink, to dry prior to output of the media. Thus, a color management resource for a printing device may include print substance formulations optimized for different media, and the printing device may modify printing process parameters based on the print substance formulations.

Print processes and print substance formulations optimized for image quality, however, can produce undesirable physical characteristics in the media that may affect the final product or make difficult further processing of media. For instance, as a piece of paper becomes more saturated with a print substance, the paper becomes less stiff, begins to suffer from cockle, which includes the wrinkling of media in areas of high print substance, and begins to curl or bend. The undesirable physical characteristics can also lead to difficulty, unreliability, or failure of finishing devices coupled to the printing device such as stapling systems and collation stackers. In addition to undesirable physical characteristics, print substance formulations optimized for image quality may occasionally generate undesirable image artifacts such as die banding, which can be characterized with uneven markings on a medium from offset print head die arrays and appear as “lighter lines” in the direction of media conveyance.

This disclosure describes a printing device that can selectively modify the amount or volume of a print substance delivered to a media based on characteristics of the printing process or on desired physical characteristics of the printed output. Such characteristics are described as process characteristics and can include characteristics of the printing process (including print speed, single sided or double sided printing, an amount of print substance applied to the medium), media (including absorbency of the medium and thickness of the medium), and environment of the printing device (including ambient temperature and humidity). A color resource can be used to transform color of a source image into a print substance formulation for a printing device based on process characteristics. For example, a printing device can include a color management resource to transform a source image into a full color print substance formulation, or full color formulation, to optimize image quality for a given medium as well as to transform a source image into another print substance formulation to account for a likelihood of a medium to cockle or curl during certain conditions of high speed print process among other contexts.

A print substance formulation based on process characteristics of the disclosure, as opposed to print substance formulations simply based on enhanced image quality, may be of interest as set forth in the disclosure. For example, a print substance formulation based on process characteristics can provide for improved output characteristics of the printed medium such as enhanced sheet flatness for improved reliability in handling the output medium, improved ability to neatly stack the media, and a greater amount of a media in a stack to be stapled. Further, the medium stiffness can be maintained and medium-to-medium friction can be reduced to improve reliability in handling and finishing. Still further, some print artifacts such as die-to-die banding can be reduced.

A process characteristic includes a characteristic of the printing process. For example, a process characteristic relates to the physical properties or attributes of the printing device or the printed medium and can include media characteristics, printing characteristics, and environmental characteristics. Process characteristics are distinguishable from a selected image quality. Example media characteristics can include stiffness of the printed medium, friction of the medium such as during sliding pages on to an output stack or from an input stack, flatness of the printed medium as affected by curl or cockle as a result of moisture in the print substance or heat applied during printing, capillary action affects of the fibers in the medium that may wick the print substance and cause bleeding in the media. The media characteristic can include a characteristic of the medium as input into the printing process or a characteristic of the medium as a result of the printing process, or media output characteristic. Example printing characteristics can include print speed and throughput of media, amount of power or energy used to drive the printing process or finishing and conditioning processes, amount of print substance remaining to complete the printing process, printing artifacts such as banding, mottle or non-uniform fill, print substance coalescence or puddles on the surface of the media, whether the medium is subjected to single sided or double sided (simplex or duplex) printing, and the presence or types of finishing devices coupled to the printing device or finishing and conditioning processes intended for the media such as stapling, hole punching, binding, laminating, folding, and collating. Printing characteristics can include maintenance issues or history of the printing device such as whether the printer is prone to jams for a selected media or image quality and whether printer components such as rollers are subjected to wear from unabsorbed print substances or exposure to print substances on, for example, rollers, shafts, or output bin that may affect print speed. Example environmental characteristics include ambient temperature, ambient humidity, or atmospheric pressure of the print process, temperature or moisture content of the media, and cost of power or type of power supplied to the print process.

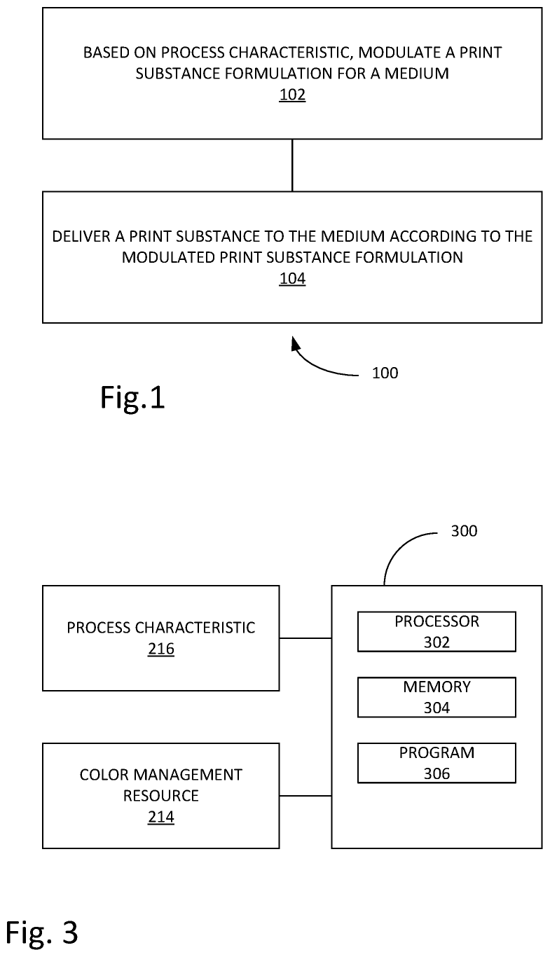

FIG. 1 illustrates an example method 100 for printing on a medium based on a process characteristic. A print substance formulation is modulated based on the process characteristic for a selected medium at 102. In one example, the print substance formulation is modulated based on a desired output characteristic of the printed medium rather than, for instance, the print process being modulated in response to a print substance formulation for a selected image quality. A print substance is delivered to the selected medium according to the print substance formulation at 104. For example, the print substance formulation can include a component having a value corresponding with an amount of a print substance, such as a volume of the print substance. In the example, the volume of the print substance is delivered to the selected medium via the printing device.

In one example, a color management resource transforms a source color in an input color space to a target color in the color space of the printing device, such as a subtractive color space. For instance, the target color can include a print substance formulation for a selected medium that includes a cyan component value, a magenta component value, a yellow component value, and a black component value. Based on the process characteristic, a component value is modulated to provide a modulated print substance formulation for that target color. In one example, all component values can be modulated. Further, a target color can include a set of modulated printed substance formulations in which each modulated print substance formulation can correspond with a different process characteristic or a different combination of process characteristics.

A color management resource can include a set of print substance formulations for a target color applied to a selected medium. One of the print substance formulations can include a full color formulation that is included to optimize image quality on the medium. The modulated print substance formulation is different than the full color formulation, and includes a formulation that is adapted to correspond with the process characteristic. For example, a process characteristic that is associated with reducing cockle or curl so as to improve collating can generate or receive a modulated print substance formulation that may improve medium flatness as an output characteristic of the medium. In this example, a full color formulation may cause a printing device to deliver a first amount of a print substance to saturate the medium, and the modulated print substance formula can cause the printing device to deliver a second amount, which is less than the first amount, of the print substance to the medium to cause less print-substance based saturation of the medium. Modulating the print substance formulation can include depleting a print substance volume such as reducing the volume of a liquid print substance at 102. Delivering the print substance to the medium at 104 includes delivering a depleted volume of the print substance.

A color management resource can be used to determine an appropriate print substance formulation. In one example, modulating the print substance formulation based on the process characteristic at 102 includes determining a print substance formulation from a color lookup table for the selected medium. Modulating the print substance formulation can include selecting one of several print substance formulations for the target color in the color lookup table. The print substance formulation can include a corresponding amount, such as volume, of the print substances associated with the values of the components of the print substance formulation.

In one example, a subset of all colors in the gamut of the printing device for the selected medium include modulated print substance formulations based on the process characteristic. For instance, print substance formulations for a full color version of a dark target color may include relatively high amounts of print substances to saturate the medium whereas the modulated print substance formulations can include relatively low amounts of print substances in order to improve flatness. But print substance formulations for a full color version of a light or pastel target color may include relatively low amounts of print substances so as to not saturate the and may include no modulation for these colors.

The modulated print substance formulation can be a combination of print substances of selected amounts to address the particular concern of the process characteristic. For example, a modulated print substance formulation of a target color to address a tendency of a full color formulation to cause a medium to cockle may include a depleted amount of the print substance volume of the full color formulation. In one example, modulating the print substance formulation can include depleting an amount of each component print substance in the full color formulation. A uniformly scaled back amount of the print substances typically produces a washed-out depiction of the source color and some source colors may appear as almost white. Users typically find target colors created from uniformly scaled back amounts of print substances to be unappealing. In another example, the modulated print substance formulation can include a combination of one, two, or three process color print substances—such as a cyan component, a magenta component, and a yellow component—made with reference to the hue of the source color. In one example, the combination of the process color components can be ten percent to thirty percent of the amount of process color used to produce the full color formulation of the source color. The modulated print substance formulation can also include a black component that has been adjusted so that the modulated print substance formulation generates a color that matches or approximates a luminous intensity of a color generated by the full color formulation version of the source color. Colors produced with modulated print substance formulations having ten percent to thirty percent of an amount of process color print substances of corresponding full color versions of the source colors provided with the selected amount of black print substances to match or approximate the luminous intensity of the source color have been demonstrated to provide a satisfactory visual appeal and dynamic range so as to be substituted for full color versions of the source colors produced by full color formulations.

The example method 100 can be implemented to include hardware devices, programs, or hardware device and programs for controlling a system having a processor and memory, to modulate, based on a process characteristic, a print substance formulation for a selected medium and to deliver a print substance to the selected medium based on the modulated print substance formulation. For example, methods 100 can be implemented as a set of executable instructions stored in a computer memory device for controlling the processor. A color management resource, as well as color gamut characterizations used to generate the color management resource, can include an array or other data structure on a memory device that replaces runtime computations with a simpler array indexing operation as a color look up table.

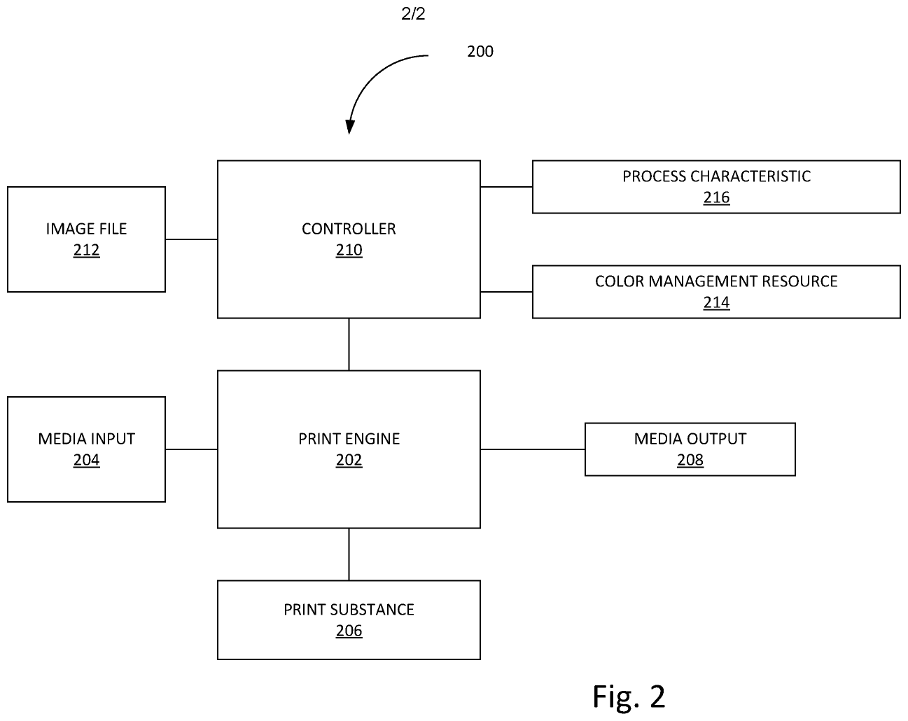

FIG. 2 illustrates an example printing device 200 that can receive digital images or digital models having a source color, implement example method 100, and produce objects or images on media. Printing device 200 includes a print engine 202 that includes mechanisms and logic to print or mark images on media. A media input 204 can provide a selected medium to the print engine 202 on which the images can be printed or marked. The print engine 202 is coupled to a consumable print substance 206, which can be used to print or mark the medium based on a print substance formulation associated with the source color. In one example, the printing device 200 can implement a subtractive color space and the print substance 206 includes each of a cyan, magenta, yellow, and black print substance. In another example, the printing device 200 can implement a greyscale color space and the print substance includes a black print substance. Examples of print engines 202 can include ink jet print engines that apply a fluid, such as a liquid print substance 206, and laser print engines that apply particles of a toner as the print substance 206. In one example, the print engine 202 delivers the print substance 206 to the medium via a print head proximate the medium. Printed media from the print engine 202 can be provided to a media output 208. In one example, the media output 208 can include or be coupled to a finishing module that can cut, collate, stack, staple, or otherwise provide the printed media in a finished form.

A controller 210, which can include a combination of hardware and programming, such as firmware stored on a memory device, is operably coupled to the print engine 202 to perform methods that control the print process. For example, the controller 210 can receive signals, such as electrical, optical, or mechanical signals, representative of a digital image 212 having a source color in an input color space to be transformed into a target color in the color space of the printing device 200. The target color includes a print substance formulation, and the controller 210 provides to the print substance formulation to the print engine 202 to deliver the print substance 206 to the selected medium according to the print substance formulation. The controller 210 is operably coupled to a color management resource 214, which can include a data structure, such as a color lookup table, stored on a memory device, to aid in the transformation of the source color into the print substance formulation. Additionally, the controller 210 is operably coupled to process characteristic sensors or process characteristic inputs to receive a signal representative of a process characteristic 216. Examples of process characteristic sensors can include temperature sensors, humidity sensors, and atmospheric pressure sensors, and examples of process characteristic inputs can include speed of the printing process, the presence of finishing or conditioning equipment, simplex or duplex printing, and amount of sheets of media to be stapled.

The signal representative of a process characteristic 216, in one example, can be provided from sensors, the finishing module, or other inputs. For examples, a printing device may have temperature or humidity sensors that provide an input to the controller 210 regarding a process characteristic. The controller 210 may receive the signals representative of the process characteristic 216 from the sensors and determine that a full color formulation will oversaturate the selected medium and modulate the print substance formulation with the color management resource 214 to reduce print substance volume. In another example, the controller 210 may receive a signal indicating the process characteristic 216 include stapling or collating a relatively large stack of media and modulate the print substance formulation with the color management resource 214 to improve flatness of the media. Based on the signals representative of the process characteristic 216, the controller 210 can modulate the print substance formulation including select a print substance formulation from a set of print substance formulations in the color management resource 214.

FIG. 3 illustrates an example system 300 including a processor 302 and memory 304 and program 306 to implement example methods 100. In one example, system 300 can be implemented with the controller 210 of the printing device 200. Program 306 can be implemented as a set of processor-executable instructions stored on a non-transitory computer readable medium such as memory 304. Computer readable media, computer storage media, or memory may be implemented to include a volatile computer storage media, nonvolatile computer storage media, or as any suitable method or technology for storage of information such as computer readable instructions, data structures, program modules or other data. A propagating signal by itself does not qualify as storage media or a memory device.

System 300 is configured to receive a signal representative of a process characteristic 216. The color management resource 214 is operably coupled to the program 306. For example, the color management resource 214 can be integrated with the program 306 or included as a separate tool that may be stored on a separate memory device. Based on a received process characteristic 216, the system 300 via the program 306 can modulate a print substance formulation for a selected medium via the color management resource 214. The system 300 via the program 306 can cause a print engine, such as a print engine including a print head, to deliver a print substance to the selected medium based on the modulated print substance formulation.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A method, comprising:
modulating, based on a process characteristic, a print substance formulation for a selected medium; and
delivering a print substance to the selected medium according to the modulated print substance formulation.

2. The method of claim 1 wherein the process characteristic includes an output characteristic of the selected medium.

3. The method of claim 1 wherein modulating the print substance formulation includes depleting a print substance amount.

4. The method of claim 3 wherein depleting the print substance amount includes depleting the print substance amount over a subset of a color space.

5. The method of claim 1 wherein modulating the print substance formulation includes determining the print substance formulation via a color lookup table.

6. The method of claim 1 wherein modulating the print substance formulation including selecting the modulated print substance formulation from a plurality of predetermined print substance formulations.

7. The method of claim 1 wherein the modulated print substance formulation includes a depleted amount of a process color.

8. The method of claim 1 wherein the delivering the print substance includes delivering a print fluid to the selected medium.

9. A printing device, comprising:
a color resource having a plurality of print substance formulations for a medium;
a controller operably coupled to the color resource, the controller to select a print substance formulation from the plurality of print substance formulations based on a process characteristic; and
a print engine operably coupled to the controller to deliver a print substance to the medium based on the selected print substance formulation.

10. The printing device of claim 9 wherein the color resource includes a color lookup table.

11. The printing device of claim 9 wherein the controller is to receive a signal representative of a process characteristic.

12. The printing device of claim 11 comprising a process characteristic sensor to provide the signal representative of the process characteristic.

13. The printing device of claim 9 wherein each print substance formulation includes a corresponding print substance volume.

14. A non-transitory computer readable medium to store computer executable instructions to control a processor to:
modulate, based on a process characteristic, a print substance formulation for a selected medium; and
deliver a print substance to the selected medium based on the modulated print substance formulation.

15. The non-transitory computer readable medium of claim 14 further comprising instructions to receive the process characteristic.
